(19) United States
(12) Patent Application Publication
(10) Pub. No.: US 2026/0152139 A1
(43) Pub. Date: Jun. 4, 2026

(54) Vehicle Rear Collision Active and Passive Protection System

(71) Applicant: ITE Tech. Inc., Hsinchu (TW)

(72) Inventor: Chung-Ping Hsu, Taipei City (TW)

(73) Assignee: ITE Tech, Inc., Hsinchu (TW)

(21) Appl. No.: 19/176,146

(22) Filed: Apr. 11, 2025

(30) Foreign Application Priority Data
Dec. 4, 2024 (TW) 113146981

(51) Int. Cl. B60R 21/0134; B60R 21/00; B60R 21/01; B60R 21/0132; B60R 21/0136; B60R 21/232; B60R 22/48

(52) U.S. Cl. CPC B60R 21/0134; B60R 21/0136; B60R 21/232; B60R 22/48; B60R 2021/0011; B60R 2021/01013; B60R 2021/01272; B60R 2021/01327

(57) ABSTRACT

A vehicle rear collision active and passive protection system includes a rear camera or a radar, a processor, and a seat belt controller. The rear camera or the radar is used to capture a dynamic image of a rear oncoming vehicle or a radar echo. The processor is used to determine whether the rear oncoming vehicle is approaching quickly or colliding based on the dynamic image or the radar echo. The seat belt controller is used to tighten a seat belt when the processor determines that the rear oncoming vehicle approaching quickly or colliding.

### BACKGROUND OF THE INVENTION

### 1. Field of the Invention

The present invention relates to a vehicle active and passive protection system, in particular to a vehicle rear collision active and passive protection system.

### 2. Description of the Prior Art

Car inflatable curtain, also known as head airbag, is a device that can pop up to cover the car window during a collision to protect the passenger's head. In the event of a side collision, the inflatable curtain can effectively separate passengers from dangerous objects such as windows, B-pillars, and seat belts, preventing their heads from directly hitting these objects, thereby reducing injuries.

Inflatable curtains are usually installed in curved steel beams on the car roof through the front and rear, and are controlled by side acceleration sensors in the vehicle. When the side acceleration reaches a dangerous value, the side acceleration sensor will activate the inflatable curtains, which has a good personnel protection function in serious accidents such as side collisions and rollovers.

The inflatable curtain has an air bag cover, a support ring, an air bag, an air bag module, etc. The car inflatable curtain is an important safety device that can effectively protect the passenger's head and reduce injuries in side collisions. During usage, the composition and troubleshooting methods of the airbag are noted to ensure its normal operation. Generally, the activation condition for inflatable curtains is when there is a side collision. However, when a rear collision occurs, the vehicle may also rotate sideways or even overturn. Therefore, a rear collision active and passive protection system is desired to activate the inflatable curtains in order to achieve the purpose of protecting passengers.

### SUMMARY OF THE INVENTION

An embodiment provides a vehicle rear collision active and passive protection system. The system includes a rear camera or a radar, a processor, and a seat belt controller. The rear camera or the radar is used to capture a dynamic image of a rear oncoming vehicle or a radar echo. The processor is used to determine whether the rear oncoming vehicle is approaching quickly or colliding based on the dynamic image or the radar echo. The seat belt controller is used to tighten a seat belt when the processor determines that the rear oncoming vehicle approaching quickly or colliding.

Another embodiment provides a vehicle rear collision active and passive protection system. The system includes a rear bumper collision sensor, a gyroscope, and an inflatable curtain controller. The rear bumper collision sensor is used to detect whether a vehicle is involved in a collision. The gyroscope is used to detect a shift in a center of gravity and uncontrolled rotation of the vehicle. The inflatable curtain controller is used to activate the inflatable curtain to protect passengers when the vehicle collides and the shift in the center of gravity meets a condition.

Another embodiment provides an active and passive protection method for vehicle rear collision. The method includes using a camera or a radar to capture a dynamic image of a rear oncoming vehicle or a radar echo, determining whether the rear oncoming vehicle is approaching quickly or colliding based on the dynamic image or the radar echo, and if it is determined that the rear oncoming vehicle is approaching quickly or colliding, using a seat belt controller to tighten a seat belt.

Another embodiment provides an active and passive protection method for vehicle rear collision. The method includes using a rear bumper collision sensor to detect whether a vehicle is involved in a collision or not, using a gyroscope to detect a shift in a center of gravity and uncontrolled rotation of the vehicle, and when the vehicle collides and the shift in the center of gravity meets a condition, activating an inflatable curtain to protect passengers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of whiplash to a passenger when a vehicle collides according to an embodiment of the present invention.

FIG. 2 is a block diagram of the vehicle collision active and passive protection system according to an embodiment of the present invention.

FIG. 3 is a flow chart of a vehicle collision active and passive protection method according to an embodiment of the present invention.

FIG. 4 is a block diagram of a vehicle collision active and passive protection system according to another embodiment of the present invention.

FIG. 5 is a flow chart of a vehicle collision active and passive protection method according to another embodiment of the present invention.

FIG. 6 is a schematic diagram of the gyroscope detecting the shift of the center of gravity of the vehicle according to an embodiment of the present invention.

FIG. 7 is a schematic diagram of a situation in which a rear vehicle collides with a front vehicle according to an embodiment of the present invention.

FIG. 8 is a schematic diagram of a situation in which a rear vehicle collides with a front vehicle according to another embodiment of the present invention.

### DETAILED DESCRIPTION

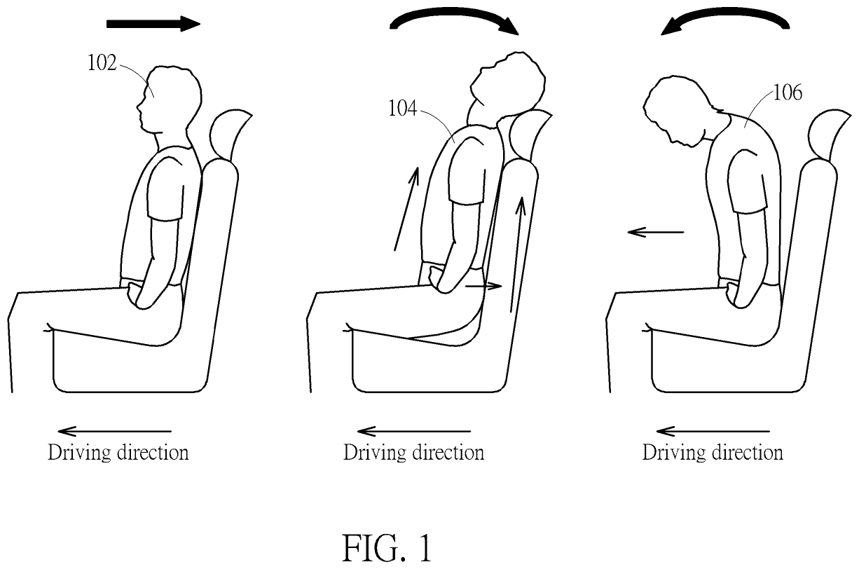

FIG. 1 is a schematic diagram of whiplash to a passenger when a vehicle collides according to an embodiment of the present invention. The driving direction of the vehicle is to the left. In the first situation 102, when the vehicle accelerates suddenly or is hit by a vehicle from behind, the passengers will receive a force toward the rear of the vehicle due to inertia (i.e., the right side in FIG. 1), so that The passenger presses against the back of the seat. If the passenger fastens the seat belt, no physical harm will be generated. In the second situation 104, if the passenger receives upward force and backward force, the neck will easily exceed the seat range and bend backward, which will cause whiplash to the neck. In this case, the seat belt may be tightened to prevent passengers from drifting upward and reduce the chance of whiplash. In the third situation 106, when the vehicle brakes suddenly or collides with another vehicle in front, the passenger will receive a forward force due to inertia (i.e., the left side in FIG. 1), causing the body to lean forward with an impact. In this case, if seat belts are tightened to secure passengers to the back of the seat, the chance of injury can be reduced. When the first situation 102, the second situation 104 and the third situation 106 occur, if the vehicle collision contains a left or right force, the vehicle collision will cause the vehicle to rotate, and then produce a left-right swing force on the passengers. In this case, the inflatable curtain needs to be activated to achieve side impact protection.

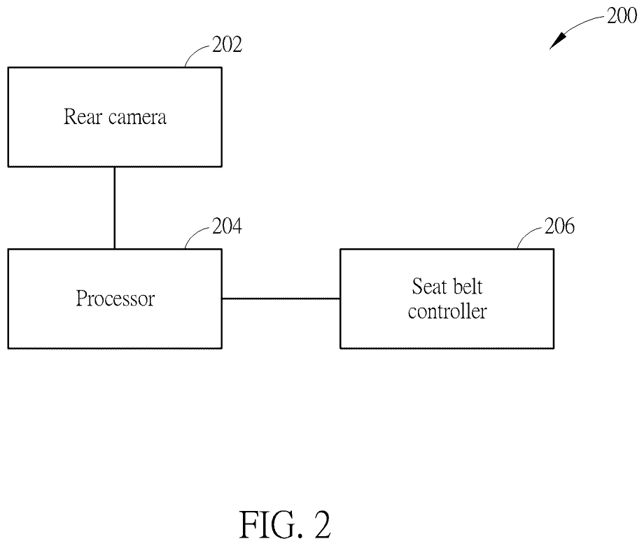

FIG. 2 is a block diagram of the vehicle collision active and passive protection system 200 according to an embodiment of the present invention. The vehicle collision active and passive protection system 200 includes a rear camera 202, a processor 204 and a seat belt controller 206. The rear camera 202 is used to capture the dynamic image of the rear oncoming vehicle, the processor 204 is used to determine whether the rear oncoming vehicle is approaching quickly based on the dynamic image of the rear oncoming vehicle, and the seat belt controller 206 is used to tighten the seat belts when the rear oncoming vehicle approaches quickly. Since the seat belt is a pre-protective device, tightening the seat belt after a collision occurs may cause whiplash in the three situations 102, 104, and 106 in FIG. 1. Therefore, in the embodiment, the seat belts are tightened when the vehicle has not yet collided to prevent whiplash injuries during the collision. The implementation method is to capture the dynamic image of the rear oncoming vehicle through the rear camera 202, and the processor 204 determines whether the rear oncoming vehicle is approaching quickly based on the dynamic image. If the rear oncoming vehicle is approaching quickly, the seat belt is tightened by using the seat belt controller 206. If not, the seat belt is in a relaxed state. The dynamic image includes a plurality of consecutive images. When the dynamic image includes a rear oncoming vehicle, the processor 204 can select the position of the rear oncoming vehicle in the image through an image recognition frame. When the size of the image recognition frame continues to increase, it means that the rear oncoming vehicle is approaching. At this case, the relative speed of the rear oncoming vehicle can be determined. If the relative speed of the rear oncoming vehicle is too high, it means that a collision may be imminent, and the seat belt should be tightened through the seat belt controller 206. In an embodiment, the processor 204 can receive dynamic images from the rear camera 202 wirelessly and control the seat belt controller 206 via wireless transmission (e.g. Wi-Fi). In another embodiment, the processor 204 may be coupled to the rear camera 202 and the seat belt controller 206 to achieve reception and control purposes. In an embodiment, the rear camera 202 can be replaced by a radar or lidar. The Radar or lidar can use radar (or lidar) echoes to determine whether a rear oncoming vehicle is approaching quickly. If the relative speed of the rear oncoming vehicle is too high, it means that a collision may be imminent, and the seat belt should be tightened by using the seat belt controller 206.

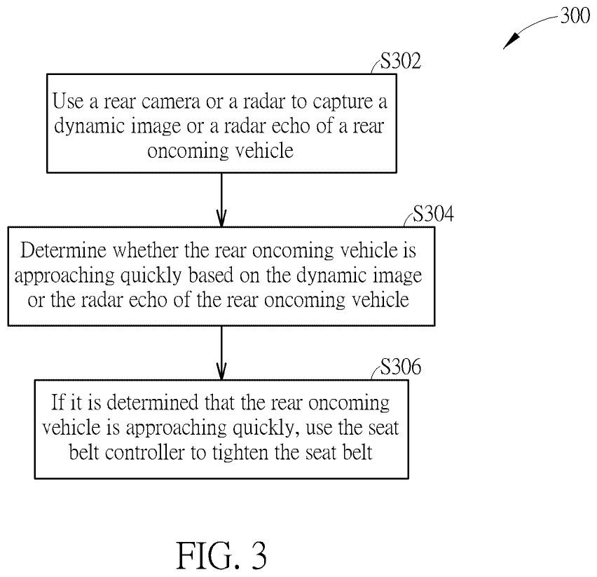

FIG. 3 is a flow chart of a vehicle collision active and passive protection method 300 according to an embodiment of the present invention. The vehicle collision active and passive protection method 300 includes the following steps:
Step S302: Use a rear camera 202 or a radar to capture a dynamic image or a radar echo of a rear oncoming vehicle;
Step S304: Determine whether the rear oncoming vehicle is approaching quickly based on the dynamic image or the radar echo of the rear oncoming vehicle; and
Step S306: If it is determined that the rear oncoming vehicle is approaching quickly, use the seat belt controller 206 to tighten the seat belt.

In step S302, the rear camera 202 or the radar is used to capture the dynamic image or the radar echo of the rear oncoming vehicle and transmit it to the processor 204. In step S304, the processor 204 determines whether the rear oncoming vehicle is approaching quickly based on the dynamic image or the radar echo of the rear oncoming vehicle. In step S306, if the processor 204 determines that the rear oncoming vehicle is approaching quickly, the seat belt controller 206 is used to tighten the seat belt to improve safety. If the processor 204 determines that the rear oncoming vehicle is not approaching quickly, the seat belt controller 206 can relax the seat belt to improve comfort.

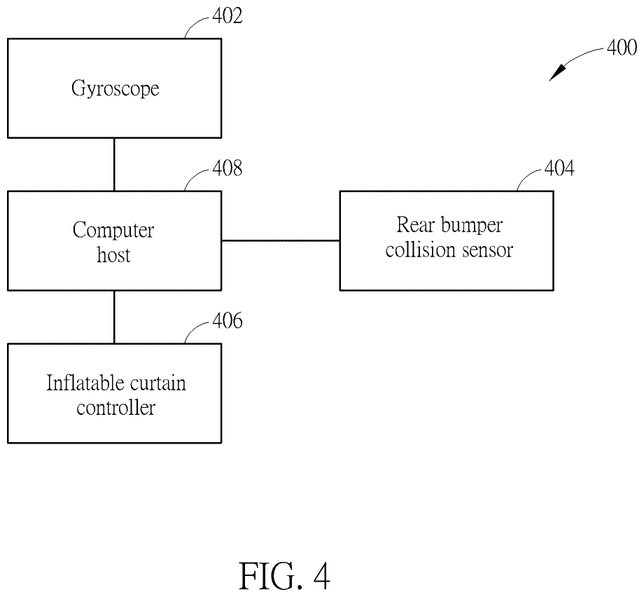

FIG. 4 is a block diagram of a vehicle collision active and passive protection system 400 according to another embodiment of the present invention. The vehicle collision active and passive protection system 400 includes a gyroscope 402, a rear bumper collision sensor 404, an inflatable curtain controller 406 and a computer host 408. The computer host 408 is coupled to the gyroscope 402, the rear bumper collision sensor 404 and the inflatable curtain controller 406. The gyroscope 402 is used to detect the shift of the vehicle's center of gravity and uncontrolled rotation, the rear bumper collision sensor 404 is used to detect whether the vehicle is involved in a collision, and the inflatable curtain controller 406 is activated to protect the passengers when the vehicle is in a collision and the shift of the center of gravity meets a condition. The gyroscope 402 can detect the magnitude and angle of the shift of the center of gravity. In one embodiment, the gyroscope 402 can also be replaced by a G sensor or an accelerometer, but the embodiment is not limited thereto. The condition is that the shift of the center of gravity exceeds a threshold and the angle of the shift of the center of gravity is within a specific range. In one embodiment, the threshold may be 1G. The condition is met when the G force detected by the gyroscope is greater than 1G and the angle of the shift of the center of gravity is within a specific range. In one embodiment, the condition includes the shift of center of gravity exceeding a threshold and being within a specific range for longer than another threshold (e.g., one second). When the shift of the center of gravity does not reach the threshold, it means that the vehicle is not out of control, but may be accelerating, turning or braking on its own actions. In this case, there is no need to activate the inflatable curtain. If the angle of the shift of the center of gravity simply falls in front or behind the vehicle, it means there is no side force, side impact and/or side-rear impact, so there is no need to activate the inflatable curtain. In other words, the conditions for the vehicle to activate the inflatable curtain must simultaneously satisfy that the shift of the center of gravity exceeds the threshold and the angle falls to the left or right of the vehicle.

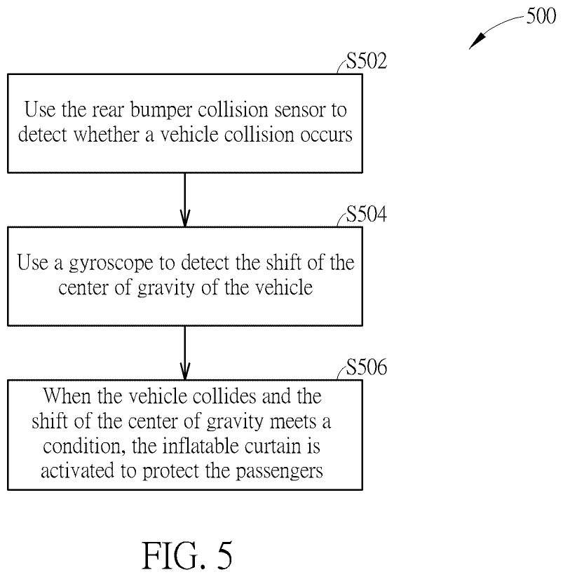

FIG. 5 is a flow chart of a vehicle collision active and passive protection method 500 according to another embodiment of the present invention. The vehicle collision active and passive protection method 500 includes the following steps:
Step S502: Use the rear bumper collision sensor 404 to detect whether a vehicle collision occurs;
Step S504: Use a gyroscope 402 to detect the shift of the center of gravity of the vehicle; and
Step S506: When the vehicle collides and the shift of the center of gravity meets a condition, the inflatable curtain is activated to protect the passengers.

In step S502, the rear bumper collision sensor 404 is used to detect whether a vehicle collision occurs. In step S504, the gyroscope 402 is used to detect the shift of the vehicle's center of gravity. In step S506, when the vehicle collides and the shift of the center of gravity meets a condition, the inflatable curtain controller 406 activates the inflatable curtain to protect the passengers. The condition is that the magnitude of the shift of the center of gravity exceeds a threshold and the shift of the center of gravity is on the left (e.g., 135 degrees to 225 degrees) or the right (e.g., 315 degrees to 45 degrees). In one embodiment, in step S506, when the rear bumper collision sensor 404 is triggered and the shift of the center of gravity meets this condition, the inflatable curtain controller 406 activates the inflatable curtain and the seat belt controller 206 tightens the seat belt to protect the passengers. In some embodiments, the inflatable curtain controller 406 can activate part of the inflatable curtains according to the angle of the shift of the center of gravity. For example, if the angle of the shift of the center of gravity is on the left (for example, 135 degrees to 225 degrees), the inflatable curtain on the left side of the vehicle will be activated. If the angle is on the right side (for example, 315 degrees to 45 degrees), the inflatable curtain on the right side of the vehicle will be activated. In some embodiments, when the shift of the center of gravity meets the conditions, the inflatable curtain controller 406 can directly activate all inflatable curtains. In one embodiment, method 300 and method 500 can be enabled at the same time or used separately, but the embodiment is not limited thereto. If method 300 and method 500 are enabled at the same time, when the rear oncoming vehicle approaches quickly, the seat belt controller 206 will tighten the seat belt. Then, when a rear collision occurs and the shift of the center of gravity meets the condition, the inflatable curtain controller 406 will activate the inflatable curtain to protect passengers, both methods 300 and 500 can be applied to the same vehicle at the same time.

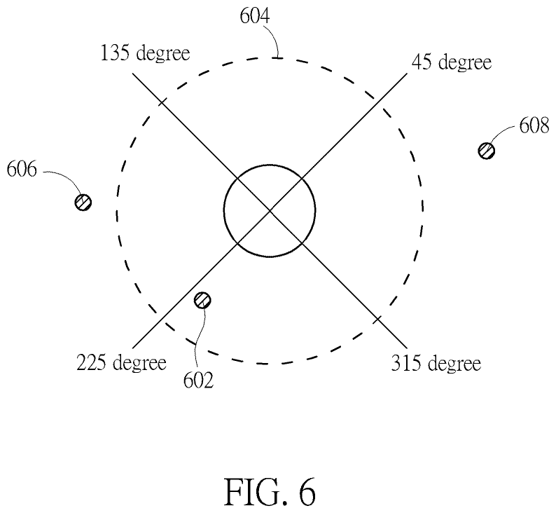

FIG. 6 is a schematic diagram of the gyroscope 402 detecting the shift of the center of gravity of the vehicle according to an embodiment of the present invention. In one embodiment, the range in front of the vehicle can be defined as between 45 degrees and 135 degrees, the range behind the vehicle can be defined as between 225 degrees and 315 degrees, the range on the left side of the vehicle can be defined as between 135 degrees and 225 degrees, and the range on the right side of the vehicle can be defined as between 315 degrees and 45 degrees. When the shift of the center of gravity is at position 602, the magnitude of the shift of the center of gravity does not reach the threshold 604, and the angle of the shift of the center of gravity falls in the range of the rear side (225 degrees to 315 degrees). Therefore, it is estimated that the state of the vehicle may be accelerating and turning. No collision occurs, and there is no need to activate the inflatable curtain. When the shift of the center of gravity is at position 606, the magnitude of the shift of the center of gravity has exceeded the threshold 604, and the angle of the shift of the center of gravity falls to the left side (135 degrees to 225 degrees), which means that the vehicle may collide and rotate rapidly to the left side, causing the passengers to swing left and right, so the inflatable curtain needs to be activated to protect the passengers. When the shift of the center of gravity is at position 608, the magnitude of the shift of the center of gravity has exceeded the threshold 604, and the angle of the shift of the center of gravity falls to the right side (315 degrees to 45 degrees), which means that the vehicle may collide and rotate rapidly to the right, causing the passengers swing left and right, so the inflatable curtain needs to be activated to protect the passengers. When the shift of the center of gravity exceeds the threshold 604 and the angle of the shift of the center of gravity falls to the left side (135 degrees to 225 degrees) or to the right side (315 degrees to 45 degrees), meaning that the condition is met, and the inflatable curtain controller 406 needs to activate the inflatable curtain to protect the passengers (e.g. rear seat passengers).

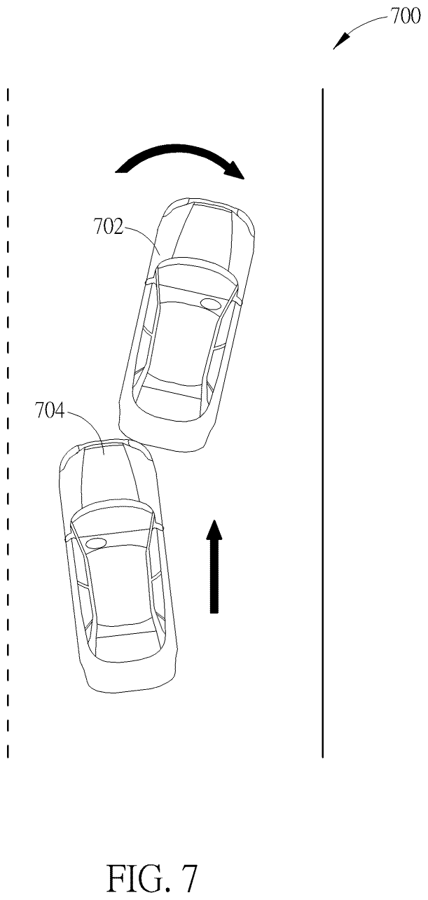

FIG. 7 is a schematic diagram of a situation 700 in which a rear vehicle collides with a front vehicle according to an embodiment of the present invention. FIG. 7 shows vehicle 702 and vehicle 704. When vehicle 704 hits the left rear of vehicle 702 from behind, it will cause vehicle 702 to rotate to the right in addition to moving forward. In this case, the rear bumper collision sensor 404 will be triggered, and the magnitude of the shift of the center of gravity detected by the gyroscope 402 exceeds the threshold 604 and the angle of the shift of the center of gravity falls to the right side (315 degrees to 45 degrees), so it is necessary to use the inflatable curtain controller 406 to activate the inflatable curtain to achieve side impact protection. If the vehicle 704 collides with the vehicle 702 close to the middle of the vehicle 702, it will not cause a rightward rotation. Although the rear bumper collision sensor 404 will be triggered in this case, the angle of the shift of the center of gravity detected by the gyroscope 402 will fall to the front side (45 degrees to 135 degrees), so the inflatable curtain controller 406 does not need to activate the inflatable curtain due to rear collision.

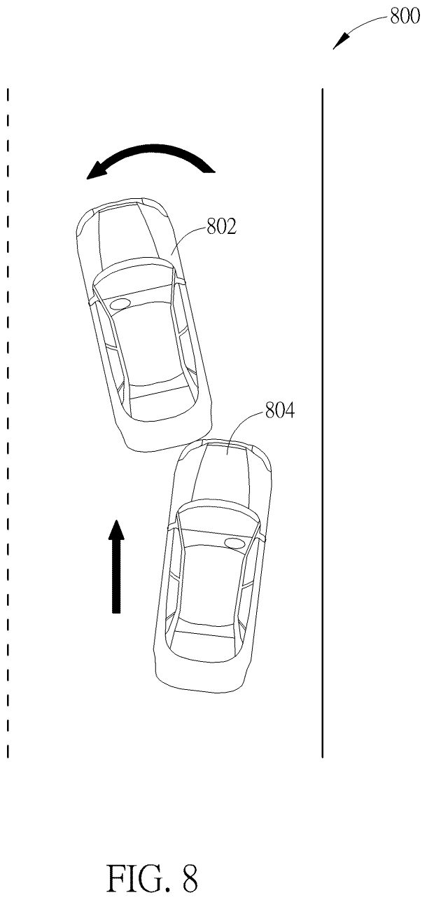

FIG. 8 is a schematic diagram of a situation 800 in which a rear vehicle collides with a front vehicle according to another embodiment of the present invention. FIG. 8 shows vehicle 802 and vehicle 804. When vehicle 804 collides with the right rear of vehicle 802 from behind, it will cause vehicle 802 to rotate to the left side in addition to moving forward. In this case, the rear bumper collision sensor 404 will be triggered, and the magnitude of the shift of the center of gravity detected by the gyroscope 402 exceeds the threshold 604 and the angle of the shift of the center of gravity will fall to the left side (135 degrees to 225 degrees), so it is necessary to use the inflatable curtain controller 406 to activate the inflatable curtain for side impact protection. If the vehicle 804 collides with the vehicle 802 close to the middle of the vehicle 802, it will not cause rotation to the left side. Although the rear bumper collision sensor 404 will be triggered in this case, the angle of the shift of the center of gravity detected by the gyroscope 402 will fall to the front side (45 degrees to 135 degrees), so the inflatable curtain controller 406 does not need to activate the inflatable curtain due to rear collision.

In one embodiment, when the rear bumper collision sensor 404 is triggered and the shift of the center of gravity detected by the gyroscope 402 exceeds the threshold 604 and the shift of the center of gravity falls to the left side (135 degrees to 225 degrees) or to the right side (315 degrees to 45 degrees), the inflatable curtain controller 406 will activate the inflatable curtain. At the same time, the processor 204 can control the seat belt controller 206 to tighten the seat belt. Although the seat belt is a pre-protection device, when a collision occurs, the seat belt controller 206 can also be used to tighten the seat belt to improve the protection effect, and activate the inflatable curtain and tighten the seat belt at the same time to ensure the safety of the passengers.

In summary, the embodiments each provide a vehicle rear collision active and passive protection system. When a rear oncoming vehicle approaches quickly, this system tightens the seat belt to prevent injury, and when a rear collision occurs and the shift of the center of gravity meets the condition, the inflatable curtain is activated to protect the passengers and increase the driving safety and reliability of the vehicle.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vehicle rear collision active and passive protection system, comprising:
a rear camera or a radar configured to capture a dynamic image of a rear oncoming vehicle or a radar echo;
a processor configured to determine whether the rear oncoming vehicle is approaching quickly or colliding based on the dynamic image or the radar echo; and
a seat belt controller configured to tighten a seat belt when the processor determines that the rear oncoming vehicle approaching quickly or colliding.

2. The vehicle rear collision active and passive protection system of claim 1, wherein the processor is coupled to the camera and the seat belt controller.

3. A vehicle rear collision active and passive protection system, comprising:
a rear bumper collision sensor configured to detect whether a vehicle is involved in a collision;
a gyroscope configured to detect a shift in a center of gravity and uncontrolled rotation of the vehicle; and
an inflatable curtain controller configured to activate the inflatable curtain to protect passengers when the vehicle collides and the shift in the center of gravity meets a condition.

4. The vehicle rear collision active and passive protection system of claim 3, wherein the condition is that the shift in the center of gravity exceeds a threshold, and an angle of the shift in the center of gravity is within a specific range.

5. The vehicle rear collision active and passive protection system of claim 4, wherein the specific range is 135 to 225 degrees and 315 to 45 degrees.

6. The vehicle rear collision active and passive protection system of claim 3, further comprising:
a seat belt controller configured to tighten a seat belt when the vehicle is involved in the collision.

7. An active and passive protection method for vehicle rear collision, comprising:
using a camera or a radar to capture a dynamic image of a rear oncoming vehicle or a radar echo;
determining whether the rear oncoming vehicle is approaching quickly or colliding based on the dynamic image or the radar echo; and
if it is determined that the rear oncoming vehicle is approaching quickly or colliding, using a seat belt controller to tighten a seat belt.

8. An active and passive protection method for vehicle rear collision, comprising:
using a rear bumper collision sensor to detect whether a vehicle is involved in a collision or not;
using a gyroscope to detect a shift in a center of gravity and uncontrolled rotation of the vehicle; and
when the vehicle collides and the shift in the center of gravity meets a condition, activating an inflatable curtain to protect passengers.

9. The active and passive protection method for vehicle rear collision of claim 8, wherein the condition is that the shift in the center of gravity exceeds a threshold, and an angle of the shift in the center of gravity is within a specific range.

10. The active and passive protection method for vehicle rear collision of claim 9, wherein the specific range is 135 to 225 degrees and 315 to 45 degrees.

11. The active and passive protection method for vehicle rear collision of claim 8, further comprising:
when the vehicle is involved in the collision, tightening a seat belt.
